(19) United States
(12) Patent Application Publication
(10) Pub. No.: US 2025/0191286 A1
(43) Pub. Date: Jun. 12, 2025

(54) VOXEL-TO-3D CONTENT GENERATOR

(71) Applicant: NVIDIA Corporation, Santa Clara, CA (US)

(72) Inventors: Zekun Hao, Santa Clara, CA (US); Ming-Yu Liu, San Jose, CA (US); Arun Mallya, Mountain View, CA (US)

(21) Appl. No.: 18/531,544

(22) Filed: Dec. 6, 2023

(51) Int. Cl. G06T 17/00; G06T 7/10; G06T 11/00; G06V 10/771; G06V 10/82

(52) U.S. Cl. CPC G06T 17/00; G06T 7/10; G06T 11/00; G06V 10/771; G06V 10/82; G06T 2207/20081

(57) ABSTRACT

A text-to-image machine learning model takes a user input text and generates an image matching the given description. As an extension to this concept, text-to-3D content models can take a user input text to generate a 3D content. However, existing text-to-3D content models require different views to be individually generated and optimized in order to form the content in 3D, which is costly in terms of computation and time, and are typically limited to the generation of 3D objects as opposed to large 3D scenes. The present description enables the creation of 3D scenes in a less costly manner by using a feed-forward neural network that can generate a 3D representation of a scene from a plurality of labeled voxels that describe the scene in 3D.

### TECHNICAL FIELD

The present disclosure relates to three-dimensional (3D) content generation.

### BACKGROUND

A text-to-image model is a machine learning model which takes as input a natural language description (i.e. a user input text) and generates an image (i.e. computer graphic) matching that description. More recently the concept of text-to-image models has been extended to 3D content. In other words, models have been created to generate 3D content from a user input text.

However, there are limitations associated with existing text-to-3D content models. In particular, current solutions randomly sample a camera view around a scene in order to convert objects in the scene to a 3D content. As a result, each generated view must be optimized by the model, typically over many optimization steps, which consumes a considerable amount of computation and requires a significant amount of time (i.e. multiple days) to complete. Additionally, the level of control offered to users by text-to-3D models is also limited.

There is a need for addressing these issues and/or other issues associated with the prior art. For example, there is a need for a feed-forward neural network that can generate a 3D representation of a scene from a plurality of labeled voxels that describe the scene in 3D.

### SUMMARY

A method, computer readable medium, and system are disclosed to provide a feed-forward neural network that generate a 3D representation of a scene from a plurality of labeled voxels that describe the scene in 3D. In an embodiment, an input that includes a plurality of labeled voxels describing a scene in 3D is processed using a feed-forward neural network to generate a 3D representation of the scene. A two-dimensional (2D) image of the scene is then generated from a given viewpoint, using the 3D representation of the scene.

In another embodiment, pseudo-ground truth images of a scene are generated from one or more given viewpoints of a procedurally generated 3D representation of the scene. Style codes are generated for the pseudo-ground truth images. A feed-forward neural network is trained to generate 2D images of the scene, using the 3D representation of the scene, the style codes, and losses on the pseudo-ground truth images.

### BRIEF DESCRIPTION OF THE DRAWINGS

FIG. 1 illustrates a flowchart of a method for voxel-to-3D content generation using a feed-forward neural network, in accordance with an embodiment.

FIG. 2 illustrates a block diagram of a system that uses a feed-forward neural network for voxel-to-3D content generation, in accordance with an embodiment.

FIG. 3 illustrates a flowchart of a method for training a feed-forward neural network to provide voxel-to-3D content generation, in accordance with an embodiment.

FIG. 4 illustrates a block diagram of a system for training a feed-forward neural network to provide voxel-to-3D content generation, in accordance with an embodiment.

FIG. 5A illustrates inference and/or training logic, according to at least one embodiment.

FIG. 5B illustrates inference and/or training logic, according to at least one embodiment.

FIG. 6 illustrates training and deployment of a neural network, according to at least one embodiment.

FIG. 7 illustrates an example data center system, according to at least one embodiment.

### DETAILED DESCRIPTION

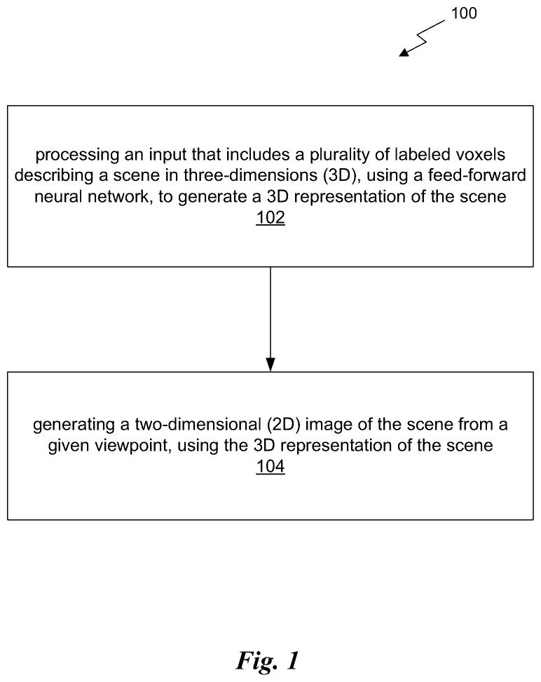

FIG. 1 illustrates a flowchart of a method 100 for voxel-to-3D content generation using a feed-forward neural network, in accordance with an embodiment. The method 100 may be performed by a device, which may be comprised of a processing unit, a program, custom circuitry, or a combination thereof, in an embodiment. In another embodiment, a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

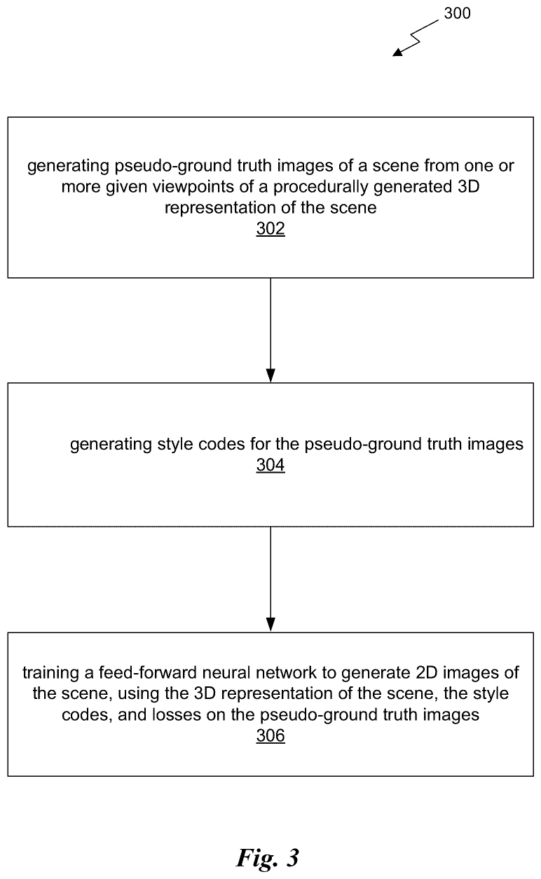

In operation 102, an input that includes a plurality of labeled voxels describing a scene in 3D is processed using a feed-forward neural network to generate a 3D representation of the scene. The feed-forward neural network refers to a machine learning model that has been trained to generate a 3D representations of a scene for a given input scene description composed of labeled voxels. Details regarding embodiments of such training will be described in more detail below with reference to FIG. 3.

The feed-forward aspect of the neural network requires that the neural network process data forward through the neural network layers. In other words, the data is processed from the input nodes of the neural network, through any hidden nodes of the neural network, to the output nodes of the neural network. In this way, the neural network be configured without any cycles or loops.

As mentioned, the input includes labeled voxels that describe the scene in 3D. In an embodiment, the input description may be manually provided by a user (e.g. via a user interface). For example, each labeled voxel may be visually represented as a block, where the user assembles the blocks to represent (e.g. describe) the 3D scene. The blocks may further be selected, customized, etc. by the user from preconfigured blocks. In an embodiment, each of the labeled voxels may have a semantic meaning, in order to describe for example specific objects in the scene, a background of the scene, etc. In an embodiment, each of the labeled voxels may be a voxel labeled with a descriptor of an object represented by the voxel.

As also mentioned, the input describing the scene is processed using (e.g. by) the feed-forward neural network to generate a 3D representation of the scene. In an embodiment, the feed-forward neural network may generate the 3D representation of the scene from the input in a single feed-forward step. In an embodiment, the feed-forward neural network may also process an input style code to generate the 3D representation of the scene. The input style code may be provided by the user and may indicate a style for the 3D representation of the scene (e.g. time of day, season, etc.).

The 3D representation that is generated by the feed-forward neural network refers to any type of representation for the scene that is three-dimensional. In an embodiment, the 3D representation of the scene may be a 3D feature map. In another embodiment, the 3D representation of the scene may be a voxel grid with features. In another embodiment, the 3D representation of the scene may be a tri-plane representation.

In operation 104, a 2D image of the scene is generated from a given viewpoint, using the 3D representation of the scene. The given viewpoint refers to any viewpoint of the 3D representation of the scene from which the 2D image of the scene is to be generated (e.g. rendered). In an embodiment, the given viewpoint may be input by the user.

In an embodiment, the given viewpoint may be defined based on an input camera pose (i.e. an input indicating the camera pose with respect to the 3D representation of the scene). In an embodiment, the given viewpoint may be controllable. For example, different 2D images of the scene may be renderable from different given viewpoints, using the 3D representation of the scene.

The 2D image of the scene may be generated using the 3D representation of the scene in various ways. In an embodiment, the 2D image may be generated by projecting the 3D representation of the scene to a 2D feature map. In an embodiment, this projection may be made via a neural radiance field rendering.

The 2D image may be defined in various formats. In an embodiment, the 2D image may be a 2D feature map. In another embodiment, the 2D image may be a photorealisic image. The 2D image, once generated, may be output on a display device for presentation to the user or may be provided a downstream task for further processing or use by an application.

In an embodiment, the method 100 may further include optimizing (e.g. refining) the 2D image of the scene. In an embodiment, the 2D image of the scene may be optimized by a second (different) feed-forward neural network. In an embodiment where the 2D image is a 2D feature map, the second feed-forward neural network may refine the 2D feature map to an output image. The output image may then be provided to the user or to a downstream task, as mentioned above.

To this end, the method 100 may be performed to provide voxel-to-3D content generation using the feed-forward neural network. In an embodiment, the method 100 converts the input description of the 3D scene (as labeled voxels) to a photorealistic 3D scene that can be rendered from any desired number of arbitrary camera poses. In an embodiment, the method 100 may be used for architectural design to allow fast and easy prototyping of the design of a property or even a city. In another embodiment, the method 100 may be used for game design to help artists and even players quickly build a game scene via simply placing blocks (representing the voxels). In yet another embodiment, the method 100 may be used for3D design to provide an easy interface, contrary to the existing complicated 3D workflow, which allows a larger group of users to do 3D design.

Further embodiments will now be provided in the description of the subsequent figures. It should be noted that the embodiments disclosed herein with reference to the method 100 of FIG. 1 may apply to and/or be used in combination with any of the embodiments of the remaining figures below.

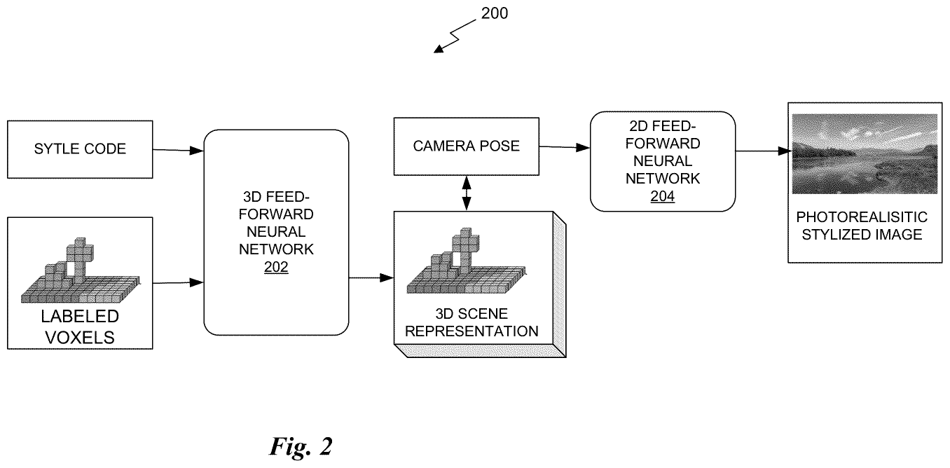

FIG. 2 illustrates a block diagram of a system 200 that uses a feed-forward neural network for voxel-to-3D content generation, in accordance with an embodiment. In an embodiment, the system 200 may be implemented to carry out the method 100 of FIG. 1. Further, the descriptions and/or definitions given above may equally apply to the present embodiment.

As shown, input in the form of labeled voxels and a style code are input to a 3D feed-forward neural network 202. In an embodiment, the labeled voxels define a 3D scene, including objects in the 3D scene and an arrangement of the 3D scene. In an embodiment, the style code indicates a style, or overall look, for the 3D scene. The style code may be selected from one of a plurality of predefined style codes.

The 3D feed-forward neural network 202 processes the input to generate a 3D scene representation. In the embodiment shown, the 3D scene representation is a 3D feature map which encodes the 3D scene. Of course, this is set forth for illustrative purposes only, and other types of 3D scene representations may be generated by the 3D feed-forward neural network 202.

Using the 3D representation of the scene, a 2D image of the scene is generated from a given viewpoint. In the embodiment shown, the given viewpoint is a camera pose. In an embodiment, the 3D feature map, as captured from the given viewpoint, is projected to a 2D feature map via neural radiance field rendering.

As further shown, the 2D image is input to a 2D feed-forward neural network 204 which refines the 2D feature map to an output 2D image. In the present system 200, different views of the same 3D scene may be rendered by varying the camera pose. To this end, the system 200 may operate such that the output scene itself is not optimized through the 3D feed-forward neural network 202. Instead, the 3D feed-forward neural network 202 generates in a feed-forward manner an appearance and geometry features of the scene in 3D, which can then be used to render 2D images from given viewpoints.

FIG. 3 illustrates a flowchart of a method 300 for training a feed-forward neural network to provide voxel-to-3D content generation, in accordance with an embodiment. The method 300 may be carried out to train the feed-forward neural network described in the method 100 of FIG. 1 and/or may be carried out to train the 3D feed-forward neural network 202 of FIG. 2. Again, the descriptions and/or definitions given above may equally apply to the present embodiment.

In operation 302, pseudo-ground truth images of a scene are generated from one or more given viewpoints of a procedurally generated 3D representation of the scene. The procedurally generated 3D representation of the scene refers to any type of representation for the scene that is procedurally (e.g. algorithmically) generated in 3D. In an embodiment, the 3D representation of the scene may be labeled. For example, the 3D representation of the scene may be a labeled 3D feature map, a plurality of labeled voxels, a labeled voxel grid with features, or a labeled tri-plane representation.

As mentioned, one or more given viewpoints of the 3D representation of the scene are used to generate the pseudo-ground truth images of the scene. The pseudo-ground truth images refer to images that are considered ground truth images of the scene for the given viewpoints. In an embodiment, each of the one or more given viewpoints may be defined based on an input camera pose. In an embodiment, the input camera pose may be a random camera pose, or in other words a randomly selected camera pose.

In an embodiment, each of the pseudo-ground truth images may be generated from a corresponding one of the given viewpoints using an image-to-image model. For example, each of the pseudo-ground truth images may be generated by: generating a segmentation mask from a given viewpoint of the procedurally generated 3D representation of the scene, and further processing the segmentation mask, using an image-to-image model, to generate the pseudo-ground truth image.

In operation 304, style codes are generated for the pseudo-ground truth images. In an embodiment, a style code may be generated for each of the pseudo-ground truth images. In an embodiment, a style code may indicate a style for a corresponding pseudo-ground truth image (e.g. time of day, season, etc.). In an embodiment, the style codes may be generated by a style encoder. For example, the style encoder may process the pseudo-ground truth images to generate the style codes for the pseudo-ground truth images.

In operation 306, a feed-forward neural network is trained to generate 2D images of the scene, using the 3D representation of the scene, the style codes, and losses on the pseudo-ground truth images. In an embodiment, the training may involve the feed-forward neural network generating 2D images from the 3D representation of the scene and the style codes. In an embodiment, the training may involve the feed-forward neural network generating 2D images from the same viewpoints as those used to generate the pseudo-ground truth images, such that each of the 2D images may have a respective pseudo-ground truth image (based on originating viewpoint).

In an embodiment, the losses may include reconstruction losses associated with the 2D images of the scene generated by the feed-forward neural network and their respective pseudo-ground truth images. For example, reconstruction losses between the 2D images and their respective pseudo-ground truth images may be computed.

In another embodiment, the losses may include a Generative Adversarial Network (GAN) loss associated with the 2D images of the scene generated by the feed-forward neural network and a training dataset. The GAN loss may be computed between each of the 2D images and a distribution of images in the training dataset. In an embodiment, the training dataset may include a random selection of 2D scene images (e.g. obtained from various sources on the Internet).

The feed-forward neural network may be trained to optimize the losses (e.g. reconstruction loss and/or GAN loss). For example, the training may be performed in iterations until a goal as it relates to the losses is achieved. For example, the goal may be a defined maximum loss allowed by the feed-forward neural network.

In an embodiment, once the feed-forward neural network is trained, it may be used to process an input describing a scene to generate a 3D representation of the scene. In an embodiment, the feed-forward neural network may generate the 3D representation of the scene from the input in a single feed-forward step. The 3D representation of the scene may then be used to generate a 2D image of the scene from any given viewpoint.

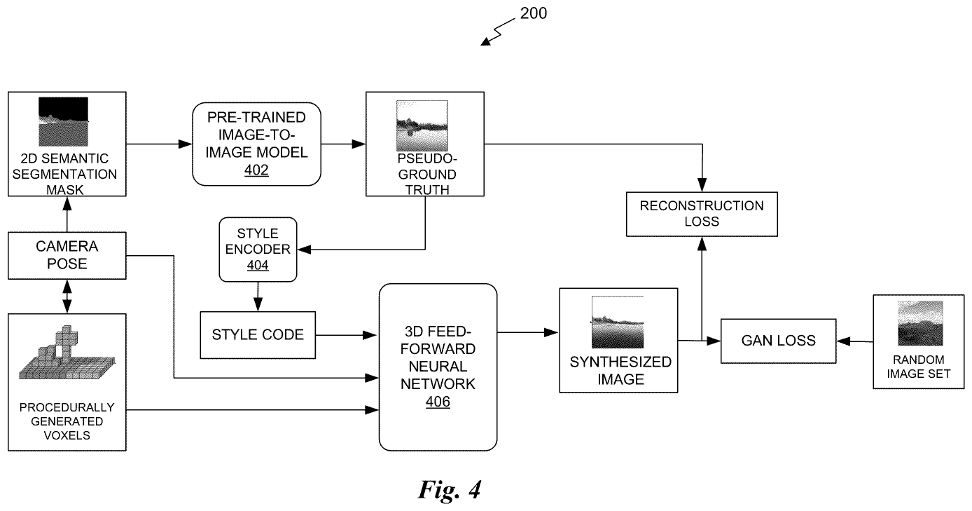

FIG. 4 illustrates a block diagram of a system 400 for training a feed-forward neural network to provide voxel-to-3D content generation, in accordance with an embodiment. In an embodiment, the system 400 may be implemented to carry out the method 300 of FIG. 3. Again, the descriptions and/or definitions given above may equally apply to the present embodiment.

As shown, a 2D semantic segmentation mask is generated by sampling a camera pose from procedurally generated voxels representing a 3D scene, and then projecting a result of the sampling to 2D. In an embodiment, the voxels may be generated by randomly sampling a voxel world using a procedural generation algorithm. The camera pose may also be randomly sampled.

The 2D semantic segmentation mask is processed by a pre-trained image-to-image model 402 to generate a corresponding image (i.e. a pseudo-ground truth). The pre-trained image-to-image model 402 may be trained on a collection of Internet images. The pseudo-ground truth is input to a style encoder 404 which predicts a style code for the pseudo-ground truth. The style encoder 404 is a trainable style encoder network.

The procedurally generated voxels, style code, and pseudo-ground truth are then input to the 3D feed-forward neural network 406 for training purposes. Thus, the procedurally generated voxels, style code, and pseudo-ground truth represent training data for the 3D feed-forward neural network 406. The 3D feed-forward neural network 406 processes the input to generate a synthesized image.

The 3D feed-forward neural network 406 is then optimized based on a computed reconstruction loss and GAN loss. The reconstruction loss is used to ensure that the synthesized image closely resembles the pseudo-ground truth. The GAN loss is used to encourage rich detail in the synthesized image by considering a difference between the synthesized image and a distribution of images in a random set of images (e.g. collected from the Internet).

The training flow described above may be iterated for multiple different procedurally generated voxels and/or camera poses, to optimize the 3D feed-forward neural network 406 toward a defined goal (e.g. a defined threshold loss). Once trained, the 3D feed-forward neural network 406 can directly convert input voxels to a renderable 3D scene in a single feed-forward step. In an embodiment, this single feed-forward step may be performed in less than one second. To this end, the 3D feed-forward neural network 406 can be used in interactive settings, for example, requiring near instant images capturing viewpoints of a 3D scene.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

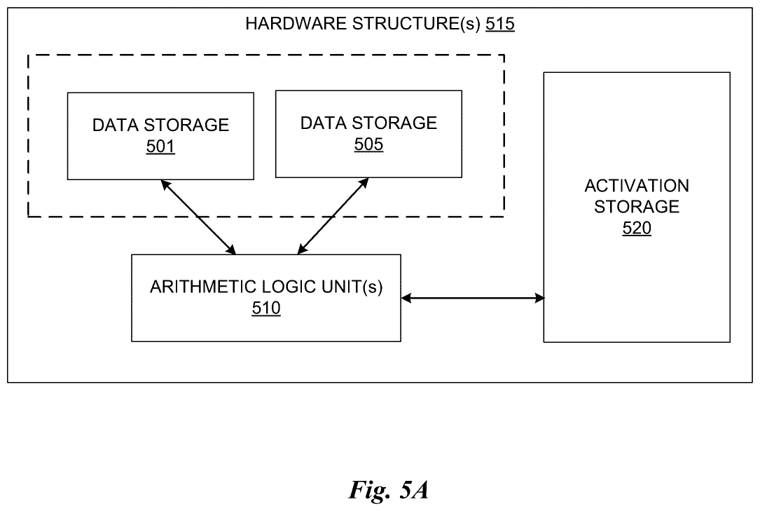

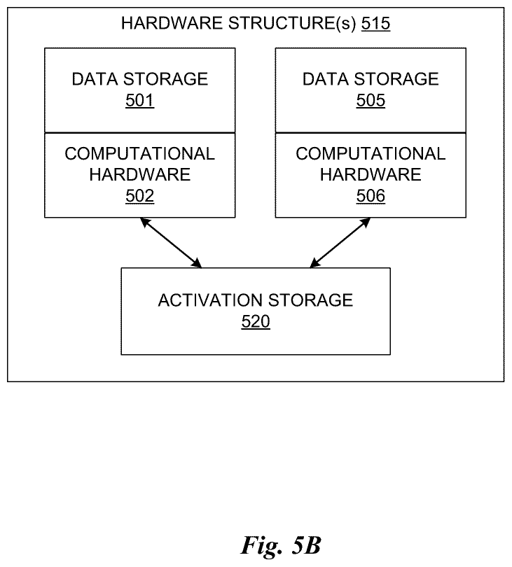

As noted above, a deep learning or neural learning system needs to be trained to generate inferences from input data. Details regarding inference and/or training logic 515 for a deep learning or neural learning system are provided below in conjunction with FIGS. 5A and/or 5B.

In at least one embodiment, inference and/or training logic 515 may include, without limitation, a data storage 501 to store forward and/or output weight and/or input/output data corresponding to neurons or layers of a neural network trained and/or used for inferencing in aspects of one or more embodiments. In at least one embodiment data storage 501 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 501 may be included with other on-chip or off-chip data storage, including a processor's L1, L2, or L3 cache or system memory.

In at least one embodiment, any portion of data storage 501 may be internal or external to one or more processors or other hardware logic devices or circuits. In at least one embodiment, data storage 501 may be cache memory, dynamic randomly addressable memory (“DRAM”), static randomly addressable memory (“SRAM”), non-volatile memory (e.g., Flash memory), or other storage. In at least one embodiment, choice of whether data storage 501 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 may include, without limitation, a data storage 505 to store backward and/or output weight and/or input/output data corresponding to neurons or layers of a neural network trained and/or used for inferencing in aspects of one or more embodiments. In at least one embodiment, data storage 505 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 505 may be included with other on-chip or off-chip data storage, including a processor's L1, L2, or L3 cache or system memory. In at least one embodiment, any portion of data storage 505 may be internal or external to on one or more processors or other hardware logic devices or circuits. In at least one embodiment, data storage 505 may be cache memory, DRAM, SRAM, non-volatile memory (e.g., Flash memory), or other storage. In at least one embodiment, choice of whether data storage 505 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 501 and data storage 505 may be separate storage structures. In at least one embodiment, data storage 501 and data storage 505 may be same storage structure. In at least one embodiment, data storage 501 and data storage 505 may be partially same storage structure and partially separate storage structures. In at least one embodiment, any portion of data storage 501 and data storage 505 may be included with other on-chip or off-chip data storage, including a processor's L1, L2, or L3 cache or system memory.

In at least one embodiment, inference and/or training logic 515 may include, without limitation, one or more arithmetic logic unit(s) (“ALU(s)”) 510 to perform logical and/or mathematical operations based, at least in part on, or indicated by, training and/or inference code, result of which may result in activations (e.g., output values from layers or neurons within a neural network) stored in an activation storage 520 that are functions of input/output and/or weight parameter data stored in data storage 501 and/or data storage 505. In at least one embodiment, activations stored in activation storage 520 are generated according to linear algebraic and or matrix-based mathematics performed by ALU(s) 510 in response to performing instructions or other code, wherein weight values stored in data storage 505 and/or data 501 are used as operands along with other values, such as bias values, gradient information, momentum values, or other parameters or hyperparameters, any or all of which may be stored in data storage 505 or data storage 501 or another storage on or off-chip. In at least one embodiment, ALU(s) 510 are included within one or more processors or other hardware logic devices or circuits, whereas in another embodiment, ALU(s) 510 may be external to a processor or other hardware logic device or circuit that uses them (e.g., a co-processor). In at least one embodiment, ALUs 510 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 501, data storage 505, and activation storage 520 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 520 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 520 may be cache memory, DRAM, SRAM, non-volatile memory (e.g., Flash memory), or other storage. In at least one embodiment, activation storage 520 may be completely or partially within or external to one or more processors or other logical circuits. In at least one embodiment, choice of whether activation storage 520 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 515 illustrated in FIG. 5A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5A may be used in conjunction with central processing unit (“CPU”) hardware, graphics processing unit (“GPU”) hardware or other hardware, such as field programmable gate arrays (“FPGAs”).

FIG. 5B illustrates inference and/or training logic 515, according to at least one embodiment. In at least one embodiment, inference and/or training logic 515 may include, without limitation, hardware logic in which computational resources are dedicated or otherwise exclusively used in conjunction with weight values or other information corresponding to one or more layers of neurons within a neural network. In at least one embodiment, inference and/or training logic 515 illustrated in FIG. 5B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 515 illustrated in FIG. 5B may be used in conjunction with central processing unit (CPU) hardware, graphics processing unit (GPU) hardware or other hardware, such as field programmable gate arrays (FPGAs). In at least one embodiment, inference and/or training logic 515 includes, without limitation, data storage 501 and data storage 505, which may be used to store weight values and/or other information, including bias values, gradient information, momentum values, and/or other parameter or hyperparameter information. In at least one embodiment illustrated in FIG. 5B, each of data storage 501 and data storage 505 is associated with a dedicated computational resource, such as computational hardware 502 and computational hardware 506, respectively. In at least one embodiment, each of computational hardware 506 comprises one or more ALUs that perform mathematical functions, such as linear algebraic functions, only on information stored in data storage 501 and data storage 505, respectively, result of which is stored in activation storage 520.

In at least one embodiment, each of data storage 501 and 505 and corresponding computational hardware 502 and 506, respectively, correspond to different layers of a neural network, such that resulting activation from one “storage/computational pair 501/502” of data storage 501 and computational hardware 502 is provided as an input to next “storage/computational pair 505/506” of data storage 505 and computational hardware 506, in order to mirror conceptual organization of a neural network. In at least one embodiment, each of storage/computational pairs 501/502 and 505/506 may correspond to more than one neural network layer. In at least one embodiment, additional storage/computation pairs (not shown) subsequent to or in parallel with storage computation pairs 501/502 and 505/506 may be included in inference and/or training logic 515.

### Neural Network Training and Deployment

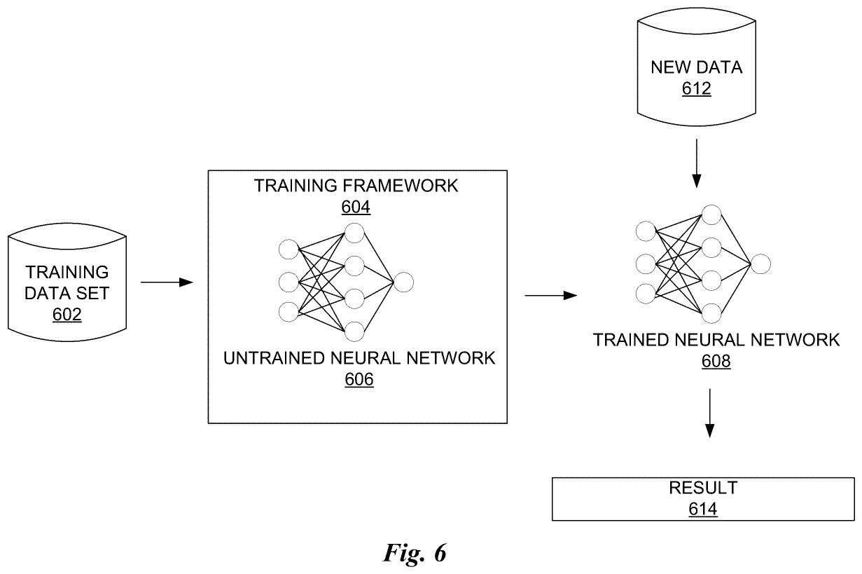

FIG. 6 illustrates another embodiment for training and deployment of a deep neural network. In at least one embodiment, untrained neural network 606 is trained using a training dataset 602. In at least one embodiment, training framework 604 is a PyTorch framework, whereas in other embodiments, training framework 604 is a Tensorflow, Boost, Caffe, Microsoft Cognitive Toolkit/CNTK, MXNet, Chainer, Keras, Deeplearning4j, or other training framework. In at least one embodiment training framework 604 trains an untrained neural network 606 and enables it to be trained using processing resources described herein to generate a trained neural network 608. In at least one embodiment, weights may be chosen randomly or by pre-training using a deep belief network. In at least one embodiment, training may be performed in either a supervised, partially supervised, or unsupervised manner.

In at least one embodiment, untrained neural network 606 is trained using supervised learning, wherein training dataset 602 includes an input paired with a desired output for an input, or where training dataset 602 includes input having known output and the output of the neural network is manually graded. In at least one embodiment, untrained neural network 606 is trained in a supervised manner processes inputs from training dataset 602 and compares resulting outputs against a set of expected or desired outputs. In at least one embodiment, errors are then propagated back through untrained neural network 606. In at least one embodiment, training framework 604 adjusts weights that control untrained neural network 606. In at least one embodiment, training framework 604 includes tools to monitor how well untrained neural network 606 is converging towards a model, such as trained neural network 608, suitable to generating correct answers, such as in result 614, based on known input data, such as new data 612. In at least one embodiment, training framework 604 trains untrained neural network 606 repeatedly while adjust weights to refine an output of untrained neural network 606 using a loss function and adjustment algorithm, such as stochastic gradient descent. In at least one embodiment, training framework 604 trains untrained neural network 606 until untrained neural network 606 achieves a desired accuracy. In at least one embodiment, trained neural network 608 can then be deployed to implement any number of machine learning operations.

In at least one embodiment, untrained neural network 606 is trained using unsupervised learning, wherein untrained neural network 606 attempts to train itself using unlabeled data. In at least one embodiment, unsupervised learning training dataset 602 will include input data without any associated output data or “ground truth” data. In at least one embodiment, untrained neural network 606 can learn groupings within training dataset 602 and can determine how individual inputs are related to untrained dataset 602. In at least one embodiment, unsupervised training can be used to generate a self-organizing map, which is a type of trained neural network 608 capable of performing operations useful in reducing dimensionality of new data 612. In at least one embodiment, unsupervised training can also be used to perform anomaly detection, which allows identification of data points in a new dataset 612 that deviate from normal patterns of new dataset 612.

In at least one embodiment, semi-supervised learning may be used, which is a technique in which in training dataset 602 includes a mix of labeled and unlabeled data. In at least one embodiment, training framework 604 may be used to perform incremental learning, such as through transferred learning techniques. In at least one embodiment, incremental learning enables trained neural network 608 to adapt to new data 612 without forgetting knowledge instilled within network during initial training.

### Data Center

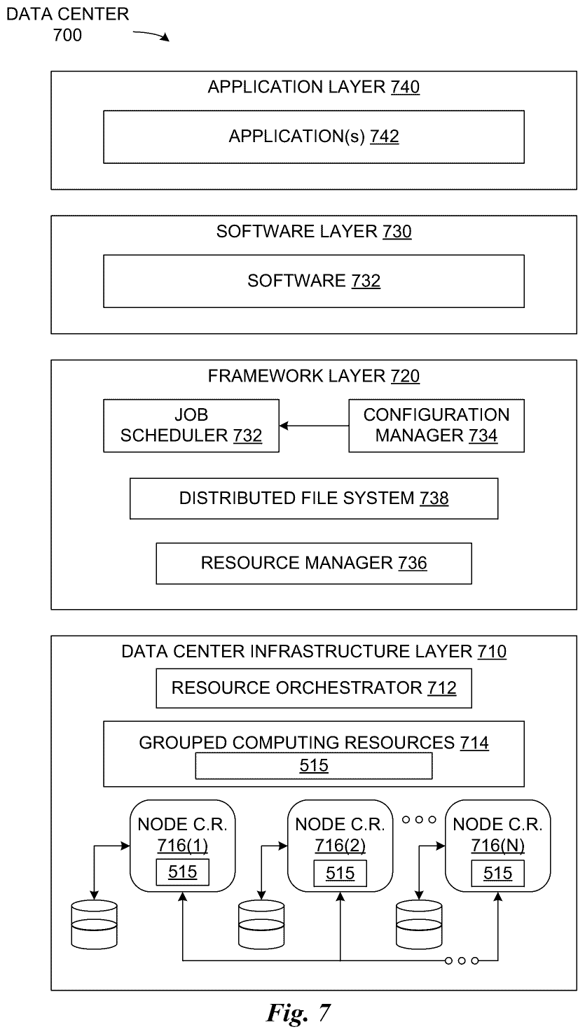

FIG. 7 illustrates an example data center 700, in which at least one embodiment may be used. In at least one embodiment, data center 700 includes a data center infrastructure layer 710, a framework layer 720, a software layer 730 and an application layer 740.

In at least one embodiment, as shown in FIG. 7, data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 716(1)-716(N) may be a server having one or more of above-mentioned computing resources.

In at least one embodiment, grouped computing resources 714 may include separate groupings of node C.R.s housed within one or more racks (not shown), or many racks housed in data centers at various geographical locations (also not shown). Separate groupings of node C.R.s within grouped computing resources 714 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 722 may configure or otherwise control one or more node C.R.s 716(1)-716(N) and/or grouped computing resources 714. In at least one embodiment, resource orchestrator 722 may include a software design infrastructure (“SDI”) management entity for data center 700. In at least one embodiment, resource orchestrator may include hardware, software or some combination thereof.

In at least one embodiment, as shown in FIG. 7, framework layer 720 includes a job scheduler 732, a configuration manager 734, a resource manager 736 and a distributed file system 738. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 732 may include a Spark driver to facilitate scheduling of workloads supported by various layers of data center 700. In at least one embodiment, configuration manager 734 may be capable of configuring different layers such as software layer 730 and framework layer 720 including Spark and distributed file system 738 for supporting large-scale data processing. In at least one embodiment, resource manager 736 may be capable of managing clustered or grouped computing resources mapped to or allocated for support of distributed file system 738 and job scheduler 732. In at least one embodiment, clustered or grouped computing resources may include grouped computing resource 714 at data center infrastructure layer 710. In at least one embodiment, resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underutilized and/or poor performing portions of a data center.

In at least one embodiment, data center 700 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700. In at least one embodiment, trained machine learning models corresponding to one or more neural networks may be used to infer or predict information using resources described above with respect to data center 700 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 515 are used to perform inferencing and/or training operations associated with one or more embodiments. In at least one embodiment, inference and/or training logic 515 may be used in system FIG. 7 for inferencing or predicting operations based, at least in part, on weight parameters calculated using neural network training operations, neural network functions and/or architectures, or neural network use cases described herein.

As described herein, a method, computer readable medium, and system are disclosed to provide a feed-forward neural network that can process an input describing a scene in 3D to generate a 3D representation of the scene. In accordance with FIGS. 1-4, embodiments may provide the feed-forward neural network usable for performing inferencing operations and for providing inferenced data. The feed-forward neural network may be stored (partially or wholly) in one or both of data storage 501 and 505 in inference and/or training logic 515 as depicted in FIGS. 5A and 5B. Training and deployment of the feed-forward neural network may be performed as depicted in FIG. 6 and described herein. Distribution of the feed-forward neural network may be performed using one or more servers in a data center 700 as depicted in FIG. 7 and described herein.

What is claimed is:

1. A method, comprising:
at a device:
processing an input that includes a plurality of labeled voxels describing a scene in three-dimensions (3D), using a feed-forward neural network, to generate a 3D representation of the scene; and
generating a two-dimensional (2D) image of the scene from a given viewpoint, using the 3D representation of the scene.

2. The method of claim 1, wherein the input description is manually provided by a user.

3. The method of claim 1, wherein each of the labeled voxels has a semantic meaning.

4. The method of claim 1, wherein each of the labeled voxels is a voxel labeled with a descriptor of an object represented by the voxel.

5. The method of claim 1, wherein the feed-forward neural network further processes an input style code to generate the 3D representation of the scene.

6. The method of claim 1, wherein the 3D representation of the scene is a 3D feature map.

7. The method of claim 1, wherein the 3D representation of the scene is a voxel grid with features.

8. The method of claim 1, wherein the 3D representation of the scene is a tri-plane representation.

9. The method of claim 1, wherein the given viewpoint is defined based on an input camera pose.

10. The method of claim 1, wherein the given viewpoint is controllable such that different 2D images of the scene are renderable from different given viewpoints, using the 3D representation of the scene.

11. The method of claim 1, wherein the 2D image is generated by projecting the 3D representation of the scene to a 2D feature map via a neural radiance field rendering.

12. The method of claim 1, further comprising, at the device:
optimizing the 2D image of the scene.

13. The method of claim 12, wherein the 2D image of the scene is optimized by a second feed-forward neural network.

14. The method of claim 1, wherein the feed-forward neural network generates the 3D representation of the scene from the input in a single feed-forward step.

15. A system, comprising:
a non-transitory memory storage comprising instructions; and
one or more processors in communication with the memory, wherein the one or more processors execute the instructions to:
process an input that includes a plurality of labeled voxels describing a scene in three-dimensions (3D), using a feed-forward neural network, to generate a 3D representation of the scene; and
generate a two-dimensional (2D) image of the scene from a given viewpoint, using the 3D representation of the scene.

16. A non-transitory computer-readable media storing computer instructions which when executed by one or more processors of a device cause the device to:
process an input that includes a plurality of labeled voxels describing a scene in three-dimensions (3D), using a feed-forward neural network, to generate a 3D representation of the scene; and
generate a two-dimensional (2D) image of the scene from a given viewpoint, using the 3D representation of the scene.

17. A method, comprising:
at a device:
generating pseudo-ground truth images of a scene from one or more given viewpoints of a procedurally generated 3D representation of the scene;
generating style codes for the pseudo-ground truth images;
training a feed-forward neural network to generate 2D images of the scene, using the 3D representation of the scene, the style codes, and losses on the pseudo-ground truth images.

18. The method of claim 17, wherein the procedurally generated 3D representation of the scene is a plurality of labeled voxels.

19. The method of claim 17, wherein each of the one or more given viewpoints is defined based on an input camera pose.

20. The method of claim 19, wherein the input camera pose is a random camera pose.

21. The method of claim 17, wherein the each of the pseudo-ground truth images is generated by:
generating a segmentation mask from a given viewpoint of the procedurally generated 3D representation of the scene,
processing the segmentation mask, using an image-to-image model, to generate the pseudo-ground truth image.

22. The method of claim 17, wherein the style codes are generated by a style encoder.

23. The method of claim 17, wherein the losses include reconstruction losses associated with the 2D images of the scene generated by the feed-forward neural network and their respective pseudo-ground truth images.

24. The method of claim 17, wherein the losses include a Generative Adversarial Network (GAN) loss associated with the 2D images of the scene generated by the feed-forward neural network and a training dataset.

25. The method of claim 24, wherein the training dataset includes a random selection of 2D scene images.
